(19) United States
(12) Patent Application Publication
(10) Pub. No.: US 2003/0056157 A1
(43) Pub. Date: Mar. 20, 2003

(54) Method and apparatus for testing network integrity

(76) Inventors: Joseph M. Fala, Honolulu, HI (US); Luis A. Wills, Honolulu, HI (US)

Correspondence Address: THE HECKER LAW GROUP, 1925 CENTURY PARK EAST, SUITE 2300, LOS ANGELES, CA, 90067, US

(21) Appl. No.: 10/236,822

(22) Filed: Sep. 5, 2002

Related U.S. Application Data
(60) Provisional application No. 60/318,178, filed on Sep. 7, 2001.

(51) Int. Cl. G11B 5/00; G06K 5/04; G11B 20/20

(52) U.S. Cl. 714/700

(57) ABSTRACT

Apparatuses and methods for testing the integrity of high speed optical fiber transmission networks are presented. Data from an optical network, for example, NRZ formatted data at forty gigabits per second and higher may be reliably recovered using embodiments of the invention. However, recovering data from high-speed networks first requires recovering the clock in NRZ transmitted data. Since, in NRZ data, there could be several samples of missing data transition edges needed for clock recovery, embodiments of the invention use hybrid microwave and high speed processing technology to reliably measure the phase shift of the data transmitted over a high speed optical transmission network and then use the phase error to provide an adjustment voltage for appropriately adjusting the recovered clock from very reliable clock generation devices such as Dielectric Resonator Oscillators (DROs). Also, an embodiment of the invention can provide a reliable means of measuring the jitter in a high-speed optical transmission network. Jitter measurement involves comparing a clock extracted from the data against a super-stable reference clock and using hybrid microwave and high speed processing technology to reliably measure the jitter (i.e., phase error).

This application claims priority of U.S. Provisional Application No. 60/318,178, filed on Sep. 7, 2001, entitled “Method and Apparatus for Testing Network Integrity,” the specification of which is herein incorporated by reference.

### BACKGROUND OF THE INVENTION

1. Field of the Invention

This invention relates to the field of transport photonics. More specifically the invention relates to physical layer transport testing of the integrity of optical network components.

2. Background Art

Originally, communication networks were constructed of copper wires for the transmission of electrical signals to communicate data and sound. For instance, some cable networks still transmit video and audio communication over copper wires. However, the demand created by a larger number of customers, need for increased programming choices, as well as increased communication distances, resulted in the proliferation of fiber optic transmission networks. This is because electrical signal transmission has very limited data carrying capability (i.e., low bandwidth) in contrast to optical transmission. Moreover, electrical based communication systems suffer from power losses (due to diffusion and skin effect) that accompany copper based transmission lines. Thus, in the telecommunications field, optical fibers and optical fiber cables have become the transmission media of choice, primarily because of the tremendous bandwidth capabilities and low power loss associated with optical fibers.

In current optical fiber communication systems, communication channels typically involve transmitting signals impressed on laser beams having different wavelengths propagating through optical fiber (e.g. Wavelength Division Multiplexing (WDM)). Although optical fiber communication systems utilizing such wavelength-distinct modulated channels may carry information over long distances, signals transmitted through optical fibers are attenuated and may be distorted due to the cumulative and combined effects of absorption and scattering. While the signal attenuation and distortion per kilometer in optical fibers used for communications are typically low, signal distortion becomes a communications factor for signals transmitted over increasing transmission distances especially when data is densely compacted using methods such as Dense Wavelength Division Multiplexing (DWDM).

DWDM is a technology that puts data from different sources together on an optical fiber, with each signal carried on its own separate light wavelength. Using DWDM, up to 80 (and theoretically more) separate wavelengths or channels of data can be multiplexed into a lightstream transmitted on a single optical fiber. Thus, in a system with each channel carrying 2.5 Gbps (billion bits per second), up to 200 billion bits can be delivered a second by the optical fiber. DWDM is also sometimes called wavelength division multiplexing (WDM).

Generally, in order to manage and control multiple wavelength optical systems (e.g. DWDM systems), information may be needed at each optical node regarding the wavelength and power of each wavelength transmitted through the system.

Optical power level and integrity monitoring becomes more critical as system topologies become more complex. Systems that used point-to-point transmissions have become increasingly complex by adding and dropping optical wavelengths, or channels, and mesh topologies, with rings of optical fiber lines for backup. Information obtained in monitoring optical transmission data can be used to change the optical parameters of a system (such as the transmitter power), regulate optical module operation parameters, and ease the fault isolation process (for example, in WDM systems). Nevertheless, in many monitoring systems, power is monitored using a different detector for each light wavelength, which can prove expensive for optical fibers carrying many wavelengths and difficult to use for people who need to maintain optical fiber transmission systems.

While monitoring power is very important, it is also important to verify the integrity of the signal carried in the different wavelengths of the DWDM system. That is, that the light traveling in all the DWDM wavelengths are at the proper height and have the right spectral components. Prior art methods for testing optical transmission integrity have very limited data rate capabilities. For example, current methods try to obtain the high data rate testing capability using Monolithic Microwave Integrated Circuits (MMIC) or high speed silicon-germanium chips. Although, the silicon-germanium chips are very fast, they still must be treated as microwave components and inserted into cavities to prevent resonant excitation thus diminishing the advantages of dye casting (i.e., high speed silicon-germanium chips). Thus, prior art systems that use all microwave components start experiencing serious drawbacks as the data frequency increases. For example, current optical network testing systems employing dye casting only operate reliably on data up to ten gigahertz.

Testing the integrity of optically transmitted data requires recovering clock and data from the input signal. In NRZ (Non-Return to Zero) format input data, the clock is not included in the data stream thus it must be recovered from the knowledge that data transitions occur at the clock frequency. Prior art methods are not reliable in recovering the clock at very high frequencies because of the nature of NRZ data. Because there is no clock in the NRZ data stream, there usually are extended periods of time where there is no data transition thus precluding a reliable means for recovering the clock signal from the incoming data stream in prior art systems. In RZ (Return to Zero) format input data, the clock is included in the data stream thus clock recovery is not necessary.

Thus, a method for reliably recovering the clock and data from a high frequency NRZ data stream is desired. Also, a method for reliably testing the integrity of optical transmission components at high frequencies is desired.

### SUMMARY OF THE INVENTION

The various embodiments of the invention described herein are directed to apparatuses and methods for testing the integrity of a network. More specifically, the one or more embodiments of the invention provide a mechanism for testing the physical transmission of data using an improved technique for processing input data streams during network testing.

Such testing is important because network performance, particularly high-speed optical networks, is dependent upon how efficiently data is handled by the network components. Thus, network engineers and others responsible for ensuring the network remains efficient find it helpful to use test devices to analyze the speed and accuracy of the various components and transport mechanisms that make up the network. In so doing, network problems can be proactively identified and resolved before becoming a significant hindrance to network performance. To effectively measure the network performance, the test device itself must be able to keep up with the transmission speeds of these components and the data traveling across the network. Because some networks (e.g., optical networks) function at very high speeds it is of the utmost importance that the test equipment be able to effectively handle certain tasks related to the processing of an input data stream. Embodiments of the invention provide embed such functionality into an optical spectrum analyzer configured to test the integrity of an optical transmission. For instance, the optical spectrum analyzer may determine whether the transmitted data is at the right height, has the right spectral component, whether there is smearing, chirping, degrading, or any other type of distortion in the transmitted data.

For data integrity testing, different colors of light may be included in one pipe to allow detailed examination of each color. One type of testing may be for extinction ratio which means, the quotient of the power level of one minus the power level of zero over the power level of zero minus the power level of no light. The other photonic testing issue may be determining whether the light signal is traveling correctly down the fiber optic network. For instance, each signal may be examined for amplitude and time variance. These tests, known as Eye, Q, and Jitter characteristics, typically require first converting the incoming optical data to electrical signals for processing. Jitter is the time movement of the signal (e.g., phase modulation), Q is the amplitude movement of the signal (e.g., amplitude modulation), and Eye is known in the art as the Eye-pattern test which is the capability to detect at the middle of the bit window and at the middle of the amplitude threshold of that bit window. For network integrity, it's critical that the data not contain too much jitter, that any amplitude modulation is minimal, that the Eye-pattern is well behaved, and that the wavelengths are in the right place. Thus, an accurate method of measuring network component integrity for high-speed data transmission is presented by embodiments of the invention.

To accomplish these data integrity tests the test equipment embodying the invention is configured to effectively handle clock recovery, data recovery, and jitter measurement of an input data stream obtained from a high-speed network.

One example of a specific type of input data stream embodiments of the invention can handle is called non-return to zero (NRZ) data. NRZ data refers to a form of digital data transmission in which the binary low and high states, represented by numerals 0 and 1, are transmitted by specific and constant DC (direct-current) voltages. One embodiment of the invention provides reliable means for recovering NRZ data from an optical network at speeds of forty gigabits per second and higher. Typically, NRZ data appears in random bit patterns with transitions occurring at the clock frequency, however, there is no clock at that frequency. However, since determination of the clock is necessary for data recovery and other integrity testing functions, the clock must be recovered from available bit patterns.

An embodiment of the invention uses hybrid microwave and high speed processing technology to reliably measure the phase shift of the data transmitted over a high speed optical transmission network and then using the phase error to provide an adjustment voltage to a very reliable clock generating device, for example, a Dielectric Resonator Oscillator (DRO).

In one embodiment of the invention, the recovered clock is used to recover the data transmitted over the high-speed network using high speed processing devices. The integrity of the recovered data can then be analyzed after the data has been properly recovered.

An embodiment of the invention uses hybrid microwave and high speed processing technology to reliably measure the jitter in a high-speed optical transmission network. Jitter measurement involves generating the phase error by comparing a clock extracted from the data against a super-stable reference clock. For instance, if the input data stream is NRZ, then the data is fed into clock extraction process where the clock may be extracted. However, if the input data stream is RZ then the clock extraction process is not necessary since RZ data contains the clock.

Thus, embodiments of the invention apply hybrid microwave and high-speed processing technology to provide programmable and adaptable apparatuses for testing the integrity of fiber optic and other network components.

### BRIEF DESCRIPTION OF THE DRAWINGS

FIG. 1 is a block diagram of a typical phase locked loop.

FIG. 2 is a block diagram overview of a clock recovery method in accordance with an embodiment of the invention.

FIG. 3 is a block diagram overview of a jitter measurement method in accordance with an embodiment of the invention.

FIG. 4 is a block diagram illustration of a clock and data recovery method from a high speed NRZ signal in accordance with an embodiment of the invention.

FIG. 5 is a block diagram of an NRZ phase detector in accordance with an embodiment of the invention.

FIG. 6 is a block diagram of a clock and data recovery using an integrated NRZ phase detector in accordance with an embodiment of the invention.

FIG. 7 is an example specification of allowable phase jitter as a function of frequency.

FIGS. 8A and 8B are schematics of a clock extraction method for a 40 GHz NRZ data in accordance with an embodiment of the invention.

FIG. 9 is a graph showing the transient responses at intermediate output locations in a clock extraction scheme in accordance with an embodiment of the invention.

FIG. 10 is a graph showing the phase linearity of the clock recovery method in accordance with an embodiment of the invention.

FIG. 11 is an example block diagram illustrating test equipment incorporating one or more embodiments of the invention.

FIG. 12 is a block diagram illustration of a jitter measurement method on a high speed NRZ signal in accordance with an embodiment of the invention.

### DETAILED DESCRIPTION OF THE INVENTION

The invention defines a method and apparatus for physical layer transport testing of optical network components. In the following description, numerous specific details are set forth to provide a more thorough description of embodiments of the invention. It will be apparent, however, to one skilled in the art, that the invention may be practiced without these specific details. In other instances, well known features have not been described in detail so as not to obscure the invention.

One or more embodiments of the invention comprise apparatuses and methods for clock recovery, data recovery, and jitter measurement of an input data stream from a high-speed optical fiber transmission network. Basically, the invention involves testing the integrity of optical network components. That is, testing of the physical transmission of optical data through optical fiber. Two photonics issues are involved in the transmission of optics and data. One of the issues is the integrity of the light traveling in all the different DWDM (dense wavelength division multiplexing) wavelengths. Thus, an embodiment of the invention may be implemented in an optical spectrum analyzer for testing the integrity of the transmission, e.g., whether the transmitted data is at the right height, has the right spectral component, whether there is smearing, chirping, degrading, or any other type of distortion in the transmitted data.

For data integrity testing, different colors of light may be included in one pipe to allow detailed examination of each color. One type of testing may be for extinction ratio which means, the quotient of the power level of one minus the power level of zero over the power level of zero minus the power level of no light. The other photonic testing issue may be determining whether the light signal is traveling correctly down the fiber optic network. For instance, each signal may be examined for amplitude and time variance. These tests, known as Eye, Q, and Jitter characteristics, typically require first converting the incoming optical data to electrical signals for processing. Jitter is the time movement of the signal (e.g., phase modulation), Q is the amplitude movement of the signal (e.g., amplitude modulation), and Eye is known in the art as the Eye-pattern test which is the capability to detect at the middle of the bit window and at the middle of the amplitude threshold of that bit window. For network integrity, it's critical that the data not contain too much jitter, that any amplitude modulation is minimal, that the Eye-pattern is well behaved, and that the wavelengths are in the right place. Thus, an accurate method of measuring network component integrity for high-speed data transmission is presented by embodiments of the invention.

Embodiments of the invention provide methods and apparatuses for measuring the integrity of optical transmission components at very high frequencies. For instance, the data to be tested may be a bitstream in the NRZ (non-return to zero) format at 40 gigabits per second and higher. However, other embodiments may test RZ (return to zero) data at high frequencies.

Typically, NRZ data appears in random bit patterns with transitions occurring at the clock frequency, however, there is no clock at that frequency. However, since determination of the clock is necessary for data recovery and other integrity testing functions, the clock must be recovered from available bit patterns. Clock determination or recovery is generally accomplished using circuits known in the art as phase locked loops (PLL).

A PLL is a closed loop feedback system where the frequency of one signal (the clock pulses from the output of a variable frequency generator) is controlled by varying the input to a variable frequency generator so that its output is locked in phase with the clock frequency from a reference source (e.g., the input data stream). This is accomplished by comparing the phase of the input data clock with the phase of the output of a Voltage Controlled Oscillator (VCO) (where the VCO is the variable frequency generator) in order to generate a phase error signal. The phase error signal is conditioned and used to adjust the VCO until the frequency of the VCO matches the frequency of the input clock.

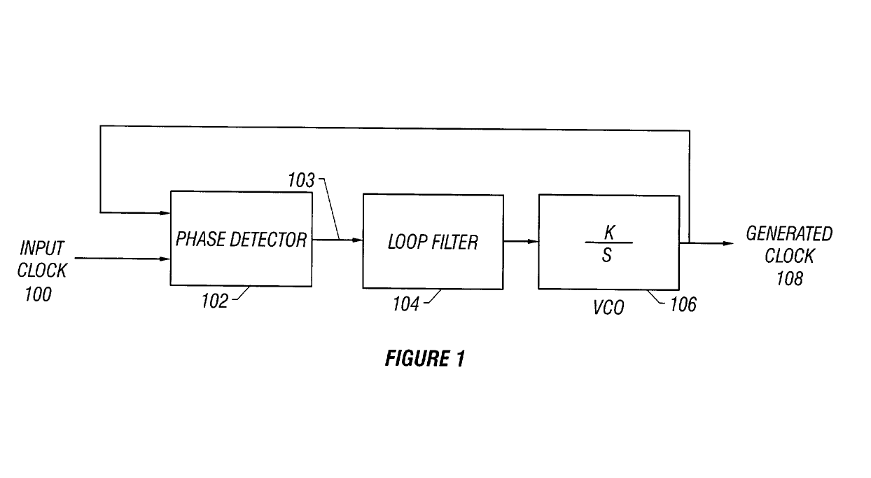

FIG. 1 is a block diagram of a typical phase locked loop. The input to the PLL is the clock of the input data stream (e.g., input clock 100). The Phase Detector, block 102, compares output of the generated frequency from the Voltage Controlled Oscillator 106 (VCO) with input clock 100 to generate the phase error between the two signals. The VCO generally acts like an integrator thereby forcing the phase error, 103, to zero in a steady state. For loop stability, phase error 103 is filtered in block 104 before being used to adjust VCO 106. When the loop stabilizes, generated clock 108, which is the output of block 106, is locked in phase (i.e. there is no phase difference) with the input data clock.

Filter block 104 is also necessary because a typical phase detector does not generate a “DC” error voltage but rather a pulsed waveform depending on the loop lock situation. For example the Motorola MC145170 PD output is a logic level signal with positive or negative going pulses (depending on how the chip is programmed). If this waveform were applied directly to the VCO a broad, frequency modulated signal would result. Therefore, the loop filter averages the phase detector output to produce a smooth voltage error for tuning the VCO.

For high speed clock and data recovery, especially in the 40 gigabits per second range, microwave components are required. However, microwave components alone may not be adequate for super fast transfer rates, e.g., 40 gigahertz or greater. Thus, embodiments of the invention apply hybrid microwave and high-speed processing technology to provide programmable and adaptable apparatuses for testing integrity of fiber optic network components. The high-speed processing technology could be digital, analog, optical, or any other means for rapidly computing trigonometric and other computation intensive functions.

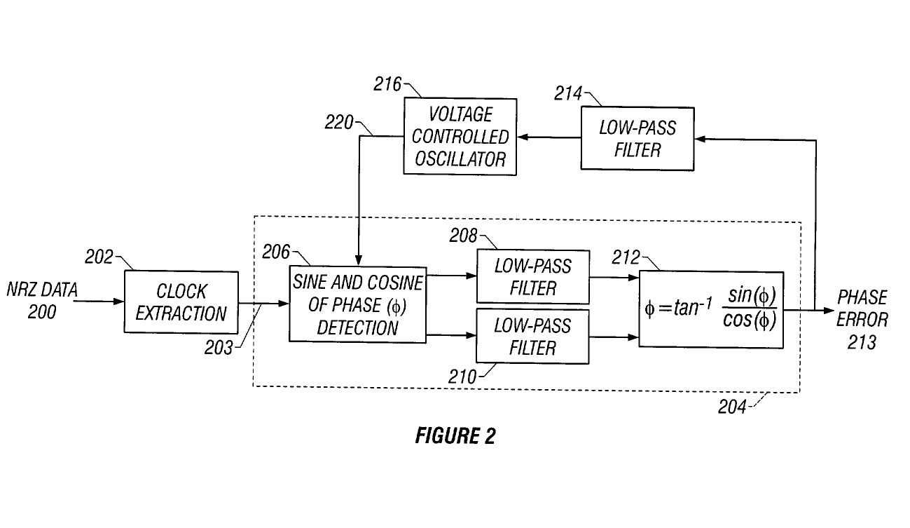

FIG. 2 is a block diagram overview of a clock recovery method in accordance with an embodiment of the invention. It comprises the clock extraction block 202, the phase detection block 204, the filter block 214, and the voltage controlled oscillator block 216. The input bitstream NRZ data 200 is fed into block 202 for extraction of the clock signal. As discussed earlier, the incoming NRZ data does not contain the clock signal. However, because data transitions occur at the clock frequency, various methods are available for extracting the clock from the NRZ data. Since the clock signal is not present in the NRZ data, there usually are several periods of missing data transition edges thereby resulting in periodic loss of the clock signal extracted in block 202. One method of clock extraction is discussed later in this specification.

The extracted clock from block 202 is fed into the phase detector block 204, which also has as input: the output of voltage controlled oscillator (VCO) 216. Output 220 of VCO 216 becomes the recovered clock signal once the phase is locked between the incoming (e.g., extracted) clock 203 and the generated/recovered clock 220. The recovered clock may then be used to recover the data and perform other integrity testing functions. Note that for RZ data, the clock 203 is present in the data stream therefore the additional step of extracting the clock is not required and the input data stream is fed directly into the phase detector.

The phase detector block 204 comprises: the Sine and Cosine of Phase Detection block 206; low-pass filter blocks 208 and 210; and phase computation block 212. At block 206, an embodiment of the invention generates the sine and cosine of the phase angle from the difference between the extracted clock (from block 202) and the generated clock (output of the VCO). The sine and cosine of the phase angle are then filtered, if necessary, in blocks 208 and 210 before being fed to block 212 for computation of the phase angle error 213. Filtering 208 and 210 may be necessary, for example, to provide analog memory for periods when there is no extracted clock data (i.e., no data transitions in NRZ format data) thus still allowing computation of the arctangent to generate the phase error in block 212. The filters also serve to smooth (i.e., generate the average) the pulsed waveform outputs of block 206 into analog DC signals. In embodiments where the computation of the arctangent is done in the digital domain, the filters may also act as anti-aliasing filters. Aliasing is a sampling phenomenon whereby resonant frequencies occurring above fifty percent of the sampling frequency appear as aliases of themselves. Thus, the function of an anti-aliasing filter is to reduce the possibility of picking up aliases of resonant frequencies occurring above fifty percent of the sampling frequency.

In embodiments in which the phase estimation process is done entirely in the analog domain, the arctangent may be approximated for small angles by the tangent obtained from the analog division of the sine and the cosine signals. Such analog division can be implemented by placing a multiplier in the feedback path of an analog multiplier device. A completely analog embodiment will afford the feedback signal to lock the VCO to the underlying clock of the data pattern using a PLL scheme. But, depending on the level of approximation, a completely analog embodiment may not allow for a real track on the phase differences between the underlying clock signal and the VCO which is required for jitter measurement.

The generated phase error, 213, is then fed into filter block 214 to stabilize the phase locked loop (notice that the circuit is essentially a PLL). Output of the filter (e.g., 214) is the tuning voltage input to the VCO, 216. The VCO then adjusts its output frequency accordingly until phase error 213 is essentially zero thereby producing the correct clock frequency at 220. In this embodiment, the output of the VCO (i.e., 220) is the recovered clock. An embodiment of the invention uses the sine and cosine of the phase error to generate the phase angle and since the sine and cosine outputs droop together in the absence of bit changes, the quotient of the sine and the cosine computed in block 212 is preserved. In prior art systems, the phase error fades to zero (i.e., is lost) when the extracted clock is lost because of missing transitions common in NRZ data.

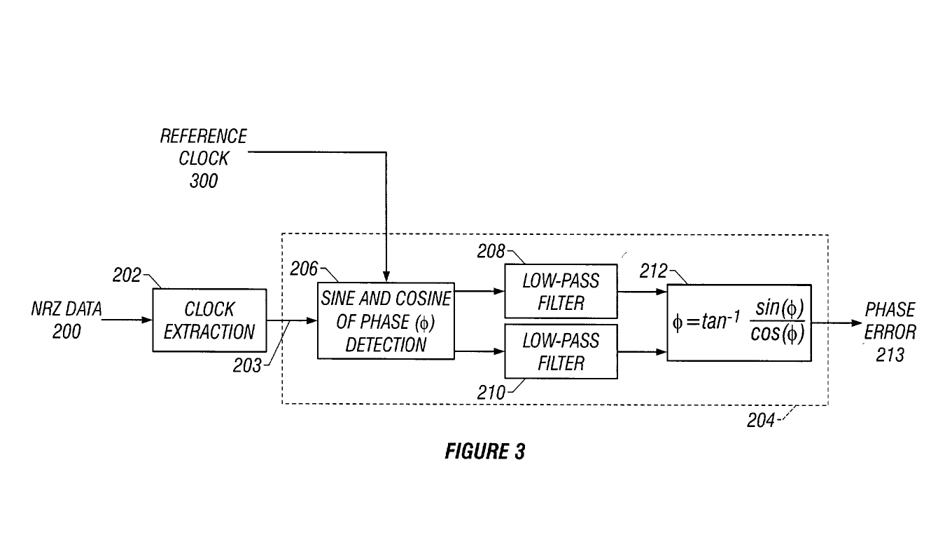

FIG. 3 is a block diagram overview of a jitter measurement method in accordance with an embodiment of the invention. It comprises clock extraction block 202 and phase detection block 204 of FIG. 2. The only difference between the schematics of FIG. 2 and FIG. 3 is that a precision and super-stable reference clock 300 is used instead of the generated clock of FIG. 2 for phase error calculation. Thus, a phase locked loop is not used in this embodiment. However, it would be apparent to those of skill in the art that the same phase locked loop discussed with respect to clock extraction above can be used for jitter measurement. The super-stable precision reference clock 300 is measured against the input data stream, i.e., extracted clock 203, to generate a phase output vector 213.

Jitter measurement requires the computation of the phase vector. The phase vector is a continuous phase signal (i.e., unwrapped) because most jitter specifications require measurements of when the phase error passes certain thresholds. Thus, the phase vector must be unwrapped (i.e., allowed to go beyond 360 degrees) and the input clock preferably compared against a super-stable clock source.

For wander measurement, the super-stable reference clock is replaced with an external clock source such as from a Global Positioning System (GPS) source. Thus, the difference between jitter and wander measurement is that for jitter, the reference clock is a super-stable clock source such as an Oven Controlled Crystal Oscillator (OXCO) while wander requires any external clock source such as GPS.

Clock And Data Recovery

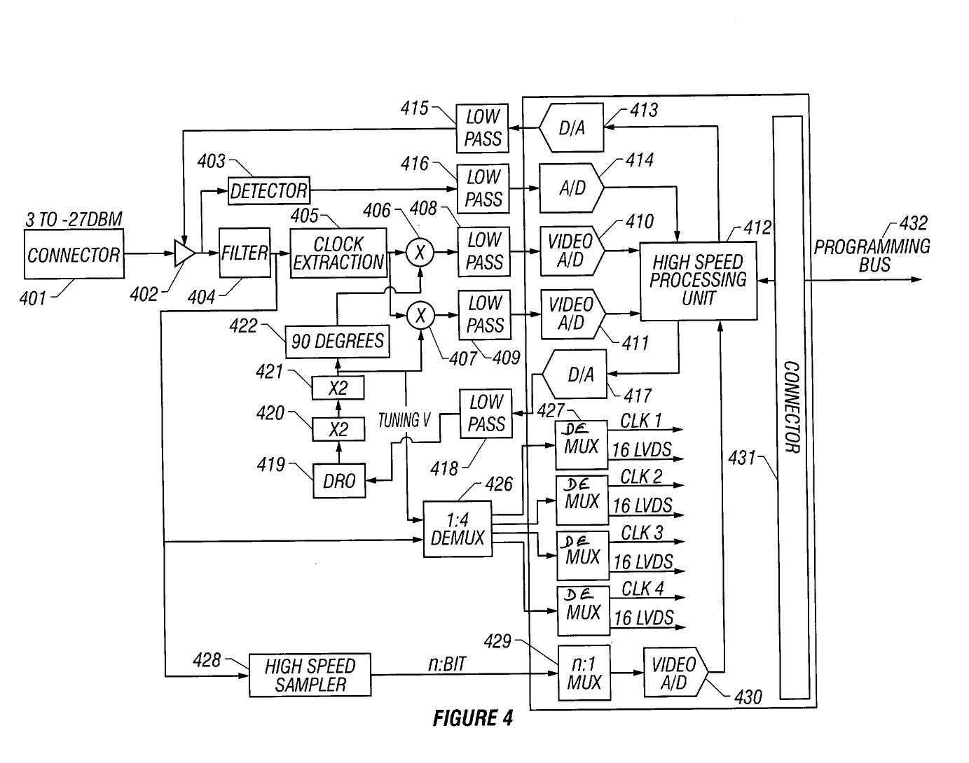

The purpose of clock recovery is to lock the reference oscillator (e.g., a VCO) to the input signal so that if the incoming data has a clock, the reference oscillator is exactly centered within one bit of the incoming clock stream. Once the clock is locked, the data can be accurately recovered. FIG. 4 is a block diagram illustration of a clock and data recovery method from a high speed NRZ signal in accordance with an embodiment of the invention. Connector 401 receives high-speed input bitstream with power ranging from 3 to −27 dbm. The input bitstream may be NRZ data in the 40 gigahertz frequency range. Note that, although the input bitstream in this embodiment is NRZ data, other embodiments may be configured to accept RZ data. As discussed earlier, NRZ data does not contain the clock signal however, since the data transitions occur at the clock frequency, the clock could be extracted from the bitstream.

The input data from connector 401 is subsequently fed into amplifier 402, which may be a variable gain amplifier. In one embodiment, the gain of the amplifier is automatically controlled by control logic in high speed processing unit 412 via a path through digital-to-analog converter (D/A) 413, and low-pass filter 415 to amplifier 402. The type and performance of D/A converter 413 depends on the frequency of the input signal through the amplifier. For example, D/A 413 could be an 8-bit high speed digital to analog converter when used for a 40 gigahertz input data. High speed processing 412 monitors the output power level of amplifier 402 from data provided by detector 403, which is connected to the output of amplifier 402, through low-pass filter 416 and analog-to-digital converter (A/D) 414.

The type and performance of A/D converter 414 depends on the frequency of the input signal through the amplifier. For example, A/D 414 could be an 8-bit high-speed analog to digital converter when used for a 40 gigahertz input data stream. In monitoring the power level of amplifier 402, high speed processing unit 412 provides closed-loop stability to amplifier 402 and makes the power level available as output to the user. Note that, in other embodiments, direct analog loop closure may be possible whereby output of detector 403 is fed directly back into amplifier 402 for stability.

High speed processing unit 412 monitor's the power level at amplifier 402 and then sets the power appropriately by adjusting the gain. Also, by controlling the power from the high speed processing unit, the invention can easily adapt to RZ clock recovery because the detector might see different levels of power between NRZ and RZ. Moreover, in embodiments having feedback directly from the detector to the amplifier, the feedback loop would either be restricted to the original design or require expensive hardware modifications for varying uses. But, with the feedback loop in the high-speed processing unit, the gain could be altered when the input data stream is switched between NRZ and RZ, for example. Also note that, although an amplifier is included in this embodiment, it would be apparent to one of skill in the art that the amplifier may be skipped entirely.

Output of amplifier 402 is fed into filter 404. Filter 404 may be a Bessel or a Gaussian filter which is typical in communication systems. In general, the choice of filter should not compromise phase response for amplitude response especially since the data being sampled is at extremely high frequencies, e.g., 40 gigahertz. Most filters characterized by flat amplitude response may have large phase shifts resulting in the signal suffering distortion of its waveform in the passband. In fiber optics data transmission, the shape of the waveform is paramount therefore necessitating a linear phase filter (or constant time delay filter). The Bessel filter (also called the Thomson filter) has maximally flat time delay within its passband. Other filter types may be used so long as they do not distort the waveform. Also, some embodiments may not use a filter. However, if it is necessary to cleanup the input signal, then a filter with minimal waveform distortion at the passband is desirable.

In embodiments where the input data stream is at 40 gigabits per second, an appropriate filter bandwidth maybe at 30 gigahertz, for example. This is because, with NRZ data, the input is actually coming at 20 gigahertz. That is, the data appears to be at half the clock rate because it's high for an entire clock period and then low for an entire clock period making a 40 gigahertz pulse appear more like a 20 gigahertz pulse. Therefore, a Bessel filter at 30 gigahertz knocks out any ringing that's close to the 40 gigahertz of the input data stream and cleans up the wave shape.

Next, if the input data stream is NRZ, then the data from filter block 404 is fed into clock extraction block 405 so that the clock may be extracted. However, if the input data stream is RZ then the clock extraction step is not necessary since RZ data contains the clock. Also, various clock extraction methods may be employed thus is not limited to those described herein. The clock extractor also acts as a frequency doubler because, as discussed earlier, the transitions for NRZ data occur at half the data frequency. An example clock extraction method is described later in this specification. The data stream for an RZ input or the extracted clock for NRZ input is fed into mixer blocks 406 and 407 for further processing.

Mixers 406 and 407 and the ninety degrees phase shifter 422 constitute a standard quadrature mixer. The output of each mixer, which represents the sine and cosine of the phase angle error, are filtered in filters 408 and 409. The mixers compare the oscillator output, which is essentially the output of Dielectric Resonator Oscillator (DRO) 419 with the input clock (e.g., output of clock extractor 405). Mixer 406 accepts the input clock and the 90-degree phase shifted variance of the generated clock (i.e., output of block 422) as its RF (Radio Frequency) and LO (Local Oscillator) inputs and produces the cosine of the phase error as its IF (Intermediate Frequency) quadrature output. Phase shifting of the generated clock may be accomplished using any device that can produce the appropriate amount of delay.

Similarly, mixer 407 accepts the input clock and the generated clock (i.e., output of block 421) as its RF and LO inputs and generates the sine of phase error as its quadrature output. The generated clock is primarily the output of the precision Dielectric Resonant Oscillator device 419 passed through any desired number of compensation blocks such as doublers 420 and 421 depending on the ratio of the input data frequency to the DRO's nominal frequency.

For example, DRO 419 may have its nominal frequency at the input frequency, in which case frequency doublers 420 and 421 are not necessary. Thus, the number of frequency doublers in any embodiment depends on the ratio of the input data frequency to the DRO nominal frequency. For example, if the input data stream is at 40 gigahertz and the DRO is a nominal 10 gigahertz clock, then two frequency doublers, 420 and 421 are necessary to bring the generated frequency up to 40 gigahertz. An implementation such as this provides the required 40 gigahertz clock and additionally clocks of various frequencies such as 10 and 20 gigahertz for other functions in the test apparatus. For example, these additionally clocks may be used for demultiplexing of the input data in demultiplexer 426.

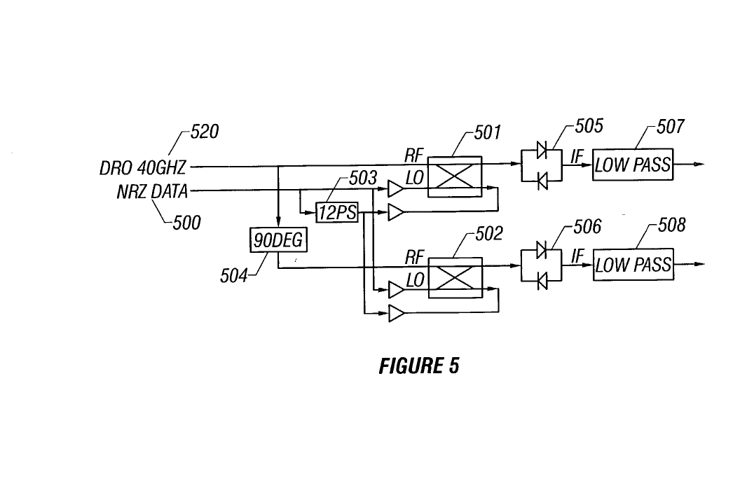

Other embodiments may use a more compact implementation combining the clock extractor 405 with mixers 406 and 407 into an apparatus referred to herein as an NRZ phase detector. Thus, the NRZ phase detector does extraction and mixing all in one block. FIG. 5 is a block diagram of an NRZ phase detector in accordance with an embodiment of the invention.

The NRZ phase detector is much more compact and it takes the place of clock extractor 405 and mixers 406 and 407. The output of a DRO 520 (e.g., 40 gigahertz) is fed into the RF (Radio Frequency) input of a mixer 501. The DRO output 520 is also delayed by 90 degrees in block 504 and fed into mixer 502. Mixers 501 and 502 also receive, into the LO (local oscillator) input, the NRZ data (i.e., 500) whose frequency is doubled by being summed with a 12.5 picosecond delayed (i.e., at block 503) variance of itself. The quadrature output of mixers 501 and 502 are then converted to DC in rectifier blocks 505 and 506, respectively. The resulting IF (intermediate frequency) outputs, which are the sine and cosine of the phase error, are filtered in low-pass filter blocks 507 and 508.

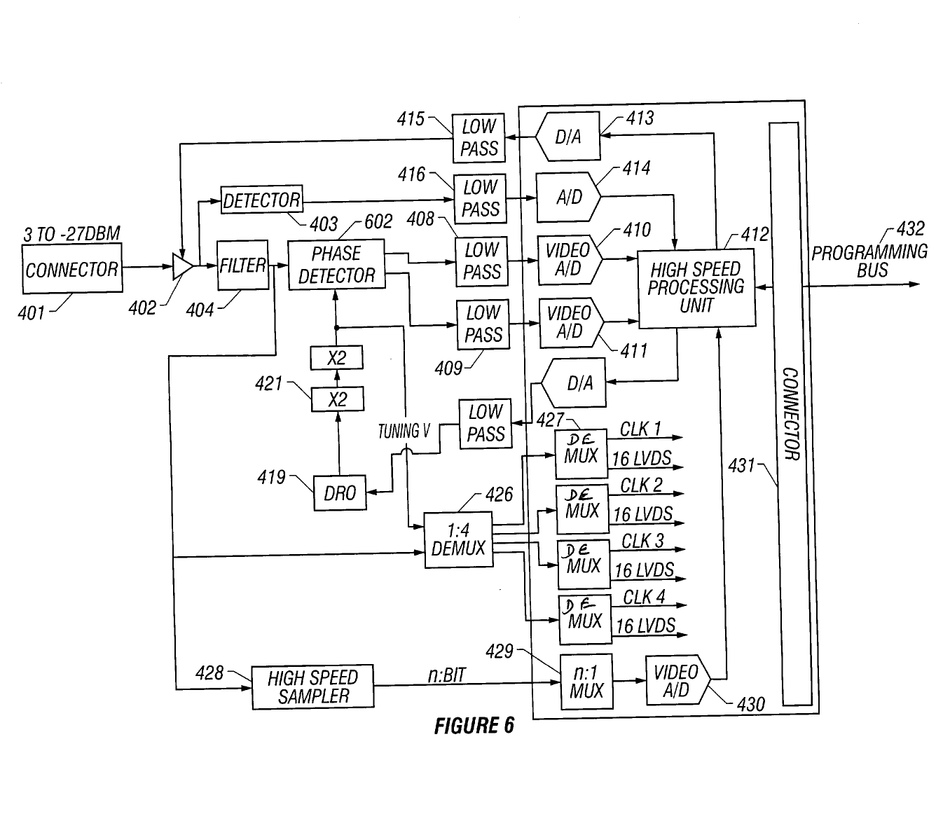

One embodiment of the invention using the NRZ phase detector is shown in FIG. 6. In this illustration, the clock extractor 405 and mixers 406 and 407 of FIG. 4 are replaced with NRZ phase detector block 602. Output of NRZ phase detector 602 are the sine and cosine of the phase error which are subsequently forwarded to low-pass filters 408 and 409. The remaining elements have functions similar to those described with respect to FIG. 4.

Referring back to FIG. 4, clock extractor 405, when acting on NRZ data, may produce a clock output with several missing pulses because of the lack of clock signal in NRZ format data. For instance, since the clock is generated from data transitions and since there may be long periods of no data transition (“1” to “0” or “0” to “1”), the extracted clock may appear for a while and then it disappears and then it comes back and it disappears and may actually disappear for quite a long time. Therefore, there is a high probability that several clock pulses could be missing. For instance, it is possible to be missing up to 5,000 pulses in some cases.

When the clock is missing, outputs of mixers 406 and 407 droop. But the key part of the invention is that the sine and cosine outputs droop together so that the quotient of the sine and the cosine is preserved. The sine and cosine output of the mixers are passed through low-pass filters 408 and 409. The low-pass filters act to hold the last value of phase if there's an absence of clock signals in the input. However, the filters hold their last value only for a finite period of time thus the sine and cosine outputs of the filters decay with time. Since the filters hold their last value for sometime, there is some memory which is like an analog memory of what the last phase angle was.

The bandwidth and type of low-pass filters 408 and 409 may be chosen appropriately based on the desired output. For instance, in embodiments that utilize the same loop structure for clock recovery and jitter measurement, if measuring jitter up to 80 Megahertz is desired, then an 80 MHz filter may be used. Using an 80 MHz filter allows reception of phase angles at 80 megahertz Bandwidth. The filter bandwidth is important in a test environment where jitter is to be presented as a frequency response. For instance, it may be necessary to present a spectrum of jitter versus frequency of jitter, i.e., jitter amplitude versus frequency of jitter. Moreover, these filters act as anti-aliasing filters. Thus, if the bandwidth of each filter is selected to be at 80 MHz, then processing unit 412 may sample (i.e. perform computations) adequately at 160 MHz or higher without picking up frequency aliases. Because, sampling at a frequency lower than 160 MHz may result in loop instability and excessive loop delay.

Output of low-pass filters 408 and 409 are passed into A/D 410 and 411 where they are quantized. The bandwidths of the A/D converters are chosen based on the desired system processing speed and accuracy. For example, an embodiment may utilize 14-bit A/D converters. The output of the A/D converters are two quantities (i.e., sine and cosine of phase) that are passed to high speed processing unit 412 where the quantities are used to determine the phase angle by computing the arctangent. Any appropriate method of rapidly computing arctangent from two quantities may be employed. For example, an embodiment may utilize one or more table lookups to minimize the number of arithmetic operations. The arctangent computation should occur at very high speeds to minimize any delay in the feedback loop. As already remarked, purely analogous implementations could provide the analog division of the sine and cosine signals as an approximation of the phase difference for small angles.

In another embodiment, the output clock phase may be varied by adding a desired phase shift as a number to the phase angle error computed by high speed processing unit 412 through the programming bus (i.e., 432) attached to connector 431. This allows introduction of predetermined phase shiftings on the recovered clock

After the phase angle error is computed in high speed processing unit 412, it is then converted back to analog in D/A block 417, and filtered through low-pass filter 418 to produce the tuning voltage for the DRO (i.e., 419). Dielectric Resonant Oscillator (DRO) 419 is a type of high performance voltage controlled oscillator (VCO). In the clock and data recovery mode of the invention, the output frequency of the DRO is tuned by a voltage error (i.e., Tuning V). For precise clock tuning, which requires high resolution signal, D/A 417 may be a 16-bit converter, for example. Additionally, compensation circuits may be added to the computed phase angle in high speed processing unit 412 to further provide stability of the closed loop system. Such compensation may include lead-lag type filtering for stabilization. The bandwidth of low-pass filter 418 depends on the desired lock frequency. For instance, 10 MHz bandwidth may be desirable when locking to the input signal, where it is desired to stabilize the loop (i.e., PLL) above 4 MHz.

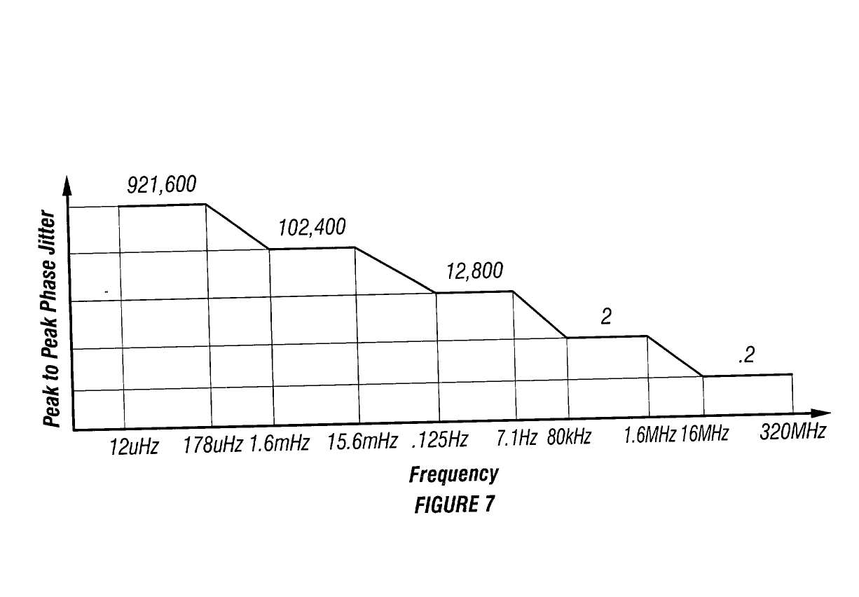

The choice of bandwidth depends on the specification requirement for loop jitter. For example, FIG. 7 shows that the allowable phase jitter is 0.2 unit intervals or 0.2 cycles at frequencies between sixteen megahertz and three hundred twenty megahertz. Thus, it is desirable to choose an appropriate bandwidth for filter 418 to meet the specification requirements for loop jitter.

The specification requirements for jitter are generally based on a range which a normal input register flip-flop sampling aperture, for example, or any other kind of device can sample. However, since the closed loop is stable and not susceptible to excessive wobbling, sampling may not really be an issue. In any case, the requirement is to stabilize the loop in the desired area before the loop jitter goes up. For example, from FIG. 7 if the bandwidth goes lower than sixteen megahertz, the jitter starts to go up very quickly. Thus, the loop should be stabilized below the cutoff point of 320 MHz and above 16 MHz as shown in FIG. 7.

The phase linearity of the present clock recovery method is shown in FIG. 10. Prior art methods do not obtain this linearity for high rate NRZ signals in the 40 GHz and higher range. Embodiments of the invention obtain this type of linearity by taking advantage of the fact that the sine and cosine of phase error droop together so their ratio is preserved and also by being able to do high-speed computations of the arctangent.

After the system locks on the input clock, output from doubler block 421 is passed as clock input to the 1:4 demultiplexer 426 (or 1:16 demultiplexer in other embodiments), which accepts the filtered input data stream from filter block 404 for data extraction. Each of the four outputs of the demultiplexer is subsequently fed into a demultiplexer 427 where they are demultiplexed with an appropriate clock signal and made available to the user in the form of low voltage differential signals. Additionally, a high speed sampler 428, which is basically a high speed demultiplexer, may be added to break the incoming data into n-samples thus slowing down the clock rate of the individual samples down to manageable values. One implementation of a high speed sampler is described in U.S. Pat. No. 5,479,120, issued to Thomas McEwan, entitled: “High Speed Sampler and Demultiplexer.”

High speed sampler 428 may be used to demultiplex the input data stream into thirty two samples thereby slowing down the input signal rate by thirty two times. Thus, a 40 gigabit per second data is slowed down to a manageable 40/32 gigabit per second sample. All thirty two outputs of high speed sampler 428 are fed into a 32:1 multiplexer 429. The manageable output of multiplexer 429 is converted into digital form by A/D converter 430 and then transmitted to high speed processing unit 412 for further processing. A/D converter 430 could be a 14-bit converter, for example.

Clock Extraction

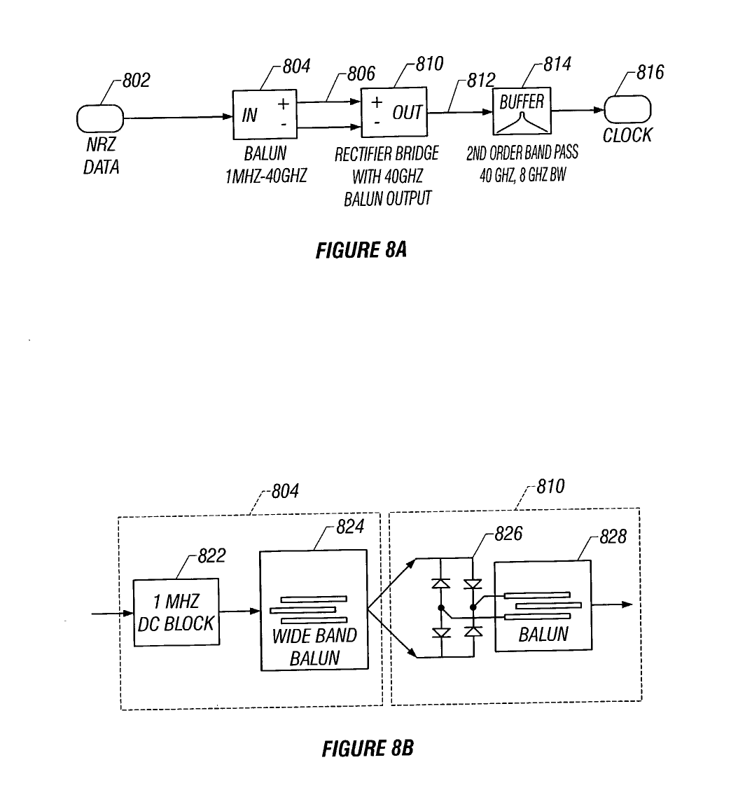

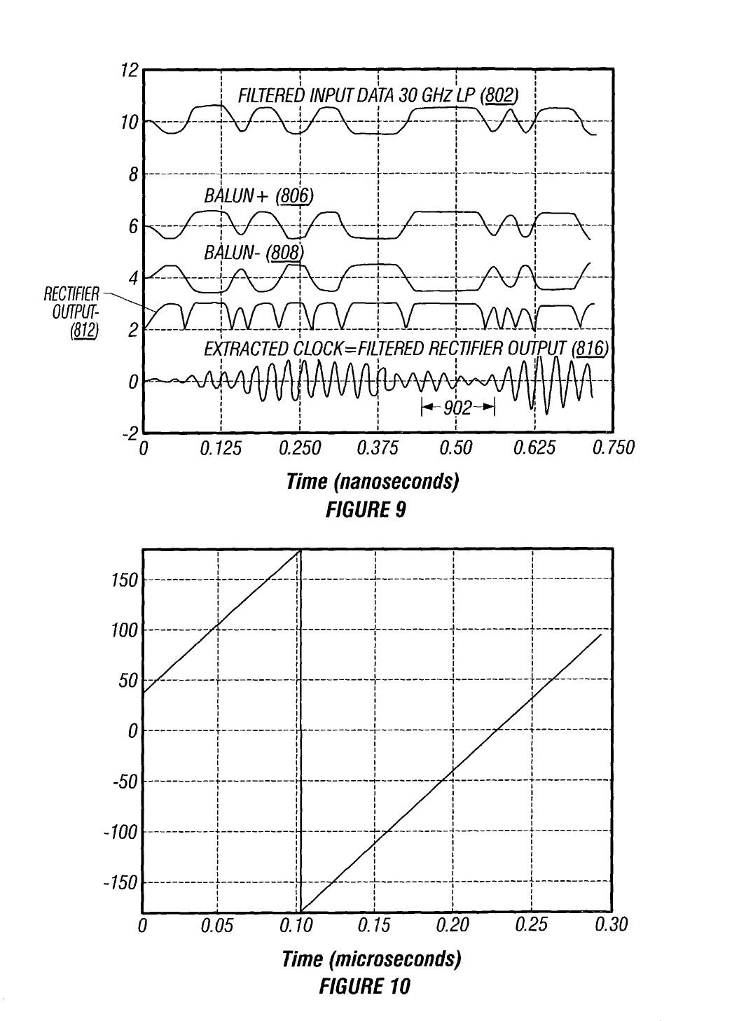

FIGS. 8A and 8B are schematics of a clock extraction method for a 40 GHz NRZ data in accordance with an embodiment of the invention. FIG. 8A is a block diagram illustration of the clock extraction method and FIG. 8B contains more detailed representation of some specific blocks of FIG. 8A. FIG. 8A will be discussed in conjunction with FIG. 9 which contains the transient responses at different pickoff points in FIG. 8A.

Referring to FIG. 8A, NRZ data at 40 gigahertz is input into connector 802. The transient response of the NRZ input data is shown as the “filtered input data” response in FIG. 9. Input data from connector 802 is fed into balun 804 which is a wide band balun. In general, a balun is a device that converts balanced signal to unbalanced signal or unbalanced signal to balanced signal. In one embodiment, balun 804 is a wide band 1 MHz to 40 GHz device which requires no delay. Balun 804 converts balanced to unbalanced and thus outputs differential signals: positive (i.e., 806) and negative (i.e., 808) signals that feed into Rectifier Bridge and Balun 810. The transient response outputs of balun 804 are shown as “Balun+” and “Balun−” in FIG. 9.

Output balun 810 produces a balanced 40 GHz rectified output. The rectifier basically generates the absolute value of the signal by converting the negative going pulses to positive. Output of balun 810 is shown in the transient response of FIG. 9 as “Rectified Output”. The rectified output from balun 810 is further passed through bandpass filter 814. In one or more embodiments, bandpass filter 814 is a second order 40 GHz bandpass filter with 8 GHz bandwidth. In other embodiments, balun 810 may also provide the function of bandpass filter 814. The extracted clock output is made available at connector 816 and shown as “Extracted Clock” in FIG. 9. As shown in FIG. 9, the extracted clock is populated where there are numerous data transitions and starts to decay where data transition is sparse, for example, at region 902.

FIG. 8B is a more detailed representation of baluns 804 and 810 of FIG. 8A. Balun 804 is composed of the low frequency blocking circuit 822 and the wide band balun 824. The rectifier in Rectifier Bridge and Balun 810 is shown in FIG. 8B as block 826 which basically comprises a plurality of Schotty diodes. The unbalanced to balanced balun is shown as block 828.

High Speed Processing Unit (HSPU)

The high speed processing unit performs several computation intensive functions and control functions. For example, the HSPU computes the arctangent from the sine and cosine of phase error to produce the phase angle. The computed phase angle is maintained in memory for use in detecting and removing phase rollover (i.e., unwrapping the phase angle). The unwrapped phase is also known as the phase vector which is important for jitter and wander measurements. The HSPU also includes compensation filters for loop stabilization; maintains logic for automatic amplifier gain adjustment; provides user interface; and other functions.

Jitter and Wander Measurement

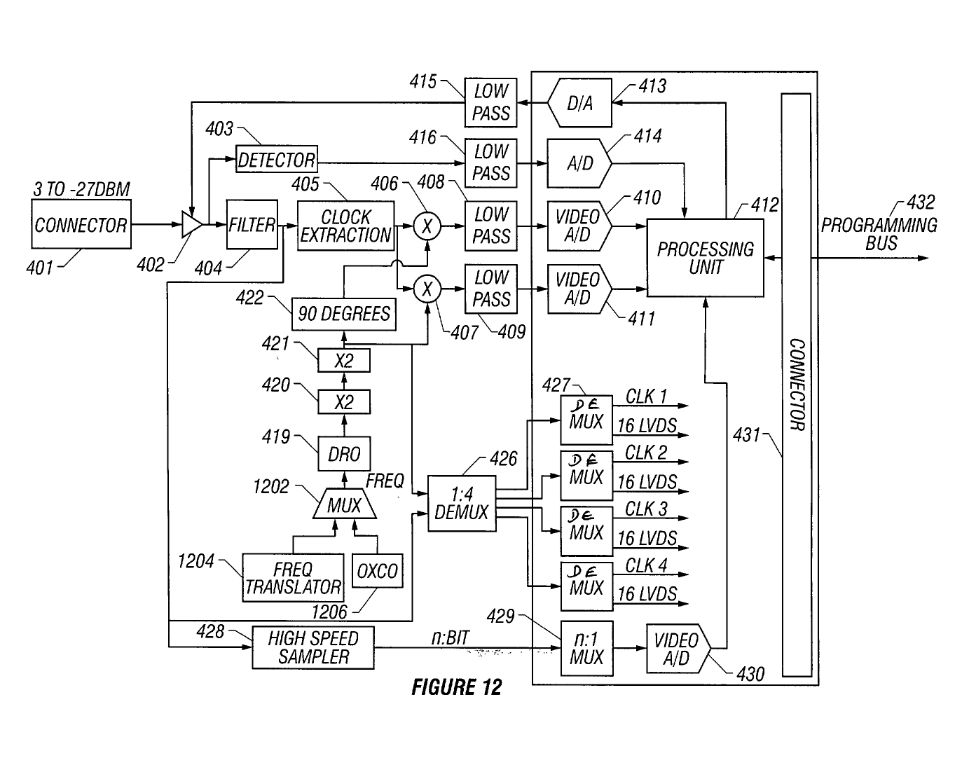

A precise and super-stable oscillator is used for jitter measurement in place of the generated clock. A type of super-stable oscillator is an oscillator producing a sinusoidal signal with extremely stable carrier frequency and with very low phase-noise profile for frequency offsets with respect to its carrier frequency. FIG. 12 is a block diagram illustration of a jitter measurement method on a high speed NRZ signal in accordance with an embodiment of the invention. As shown in this illustration, jitter measurement circuit is similar to that used for clock extraction (FIG. 4). However, for jitter measurement, the phase locked loop is not closed, i.e., D/A converter 417 and low-pass filter 418 are not used, instead a precision reference and super-stable clock source is used. The precision reference clock has a frequency equal to the transmission data frequency. Thus, instead of the tuning voltage of FIG. 4 feeding into DRO 419, a precision frequency source (i.e., Freq) is fed from multiplexer 1202 into DRO 419. Output of multiplexer 1202 is generated by multiplexing Frequency Translator 1204 and output of Oven Controlled Crystal Oscillator (OXCO) 1206. In this configuration, the DRO follows the precision reference clock instead of the input data stream. Thus, jitter is measured against a super-stable clock.

Jitter measurement requires the computation of the phase vector. The phase vector is a continuous phase signal (i.e., unwrapped) because most jitter specifications require measurements of when the phase error passes certain thresholds. Thus, the phase vector must be unwrapped (i.e., allowed to go beyond 360 degrees) and the input clock preferably compared against a super-stable clock source. Unwrapping of the phase angle occurs in high-speed processing unit 412.

For wander measurement, the super-stable reference clock is replaced with an external clock source such as from a Global Positioning System (GPS) source. Thus, the difference between jitter and wander measurement is that for jitter, the reference clock is a super-stable clock source such as an Oven Controlled Crystal Oscillator (OXCO) while wander requires any external clock source such as GPS.

An Example General Purpose Test Equipment Configuration

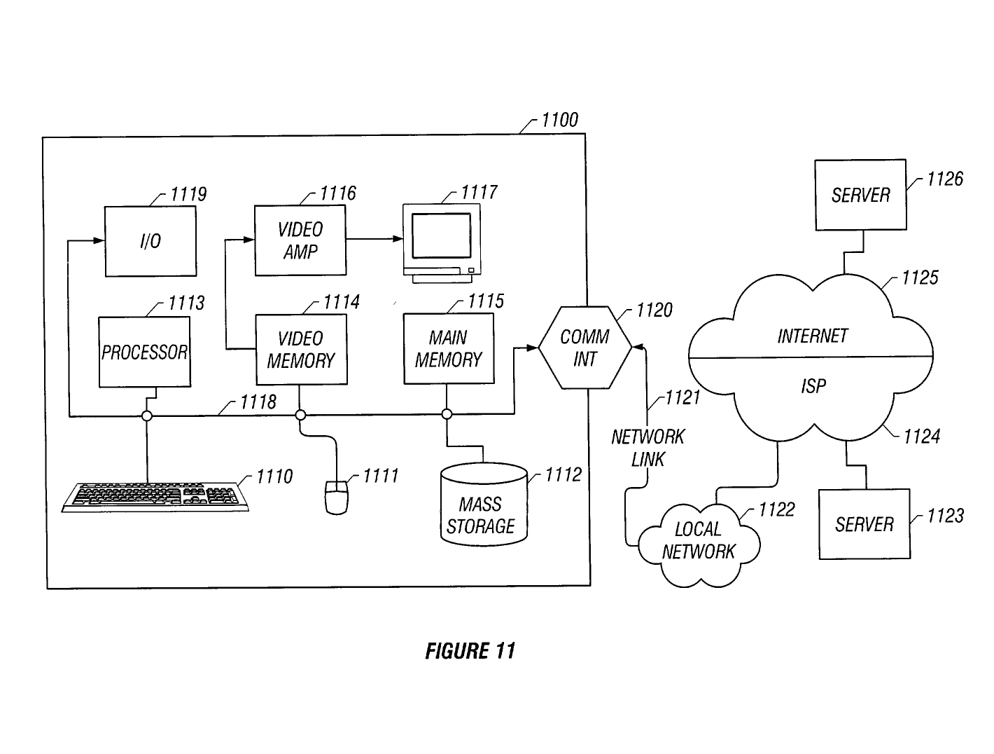

An embodiment of the invention may be implemented on any computer processing platform, or in the form of software (e.g., bytecode class files) that is executable within a runtime environment running on such a processing platform. An example of implementation of test equipment incorporating an embodiment of the invention is illustrated in the computer of FIG. 11. The computer system (or test equipment) described below is for purposes of example only.

In FIG. 11, keyboard 1110 and mouse 1111 are coupled to system bus 1118. The keyboard and mouse are for introducing user input to the computer system (test equipment) and communicating that user input to processor 1113. Other suitable input devices may be used in addition to, or in place of, the mouse 1111 and keyboard 1110. For example, computer 1100 may be a set top box without a mouse or even keyboard. I/O (input/output) unit 1119 coupled to system bus 1118 represents such I/O elements as a printer, A/V (audio/video) I/O, inputs from A/D converters, outputs to D/A converters, etc.

Computer 1100 includes a video memory 1114, main memory 1115 and mass storage 1112, all coupled to system bus 1118 along with keyboard 1110, mouse 1111 and processor 1113. The mass storage 1112 may include both fixed and removable media, such as magnetic, optical or magnetic optical storage systems or any other available mass storage technology. Bus 1118 may contain, for example, address lines for addressing video memory 1114 or main memory 1115. The system bus 1118 also includes, for example, a data bus for transferring data between and among the components, such as processor 1113, main memory 1115, video memory 1114 and mass storage 1112. Alternatively, multiplexed data/address lines may be used instead of separate data and address lines.

In one embodiment of the invention, the processor 1113 is a SPARC™ microprocessor from Sun Microsystems, Inc. or a microprocessor manufactured by Intel, such as the 80×86, or Pentium processor, or a microprocessor manufactured by Motorola, such as the 680×0 processor. However, any other suitable microprocessor or microcomputer, such as FPGAs may be utilized. Main memory 1115 is comprised of dynamic random access memory (DRAM). Video memory 1114 is a dual-ported video random access memory. One port of the video memory 1114 is coupled to video amplifier 1116. The video amplifier 1116 is used to drive the cathode ray tube (CRT) raster monitor 1117. Video amplifier 1116 is well known in the art and may be implemented by any suitable apparatus. This circuitry converts pixel data stored in video memory 1114 to a raster signal suitable for use by monitor 1117. Monitor 1117 is a type of monitor suitable for displaying graphic images. Alternatively, the video memory could be used to drive a flat panel or liquid crystal display (LCD), or any other suitable data presentation device.

Computer 1100 may also include a communication interface 1120 coupled to bus 1118. Communication interface 1120 has a two-way data communication with the components of the test equipment 1100. Communication link 118 may be equivalent to programming link 432 (see FIG. 4). Communication interface 1120 includes connector 401 for receiving transmission data via a network link 1121 of a local network 1122. Embodiments of the invention maybe implemented in communication interface 1120 thereby interfacing the user interface testing equipment 1100 with the transmission line, 1121, under test. In such implementation, network link 1121 may be an optical transmission link.

Network link 1121 typically provides data communication through one or more networks to other data devices. For example, network link 1121 may provide a connection through local network 1122 to local server computer 1123 or to data equipment operated by an Internet Service Provider (ISP) 1124. ISP 1124 may in turn provide data communication services through the world wide packet data communication network now commonly referred to as the “Internet” 1125. Local network 1122 and Internet 1125 both use electrical, electromagnetic or optical signals which carry digital data streams. The signals through the various networks and the signals on network link 1121 through communication interface 1120, which carry the optical data to computer/test equipment 1100, are exemplary forms of carrier waves transporting the information.

In one or more embodiments, HSPU 412 may be implemented inside computer 1100 thus minimizing the number of processors in computer 1100. In such embodiments, processor 1113 is a multi-purpose processor providing the high priority and deterministic function required by HSPU 412 and other test equipment processing functions.

Thus, a method and apparatus for physical layer transport testing of optical network components have been described in conjunction with one or more specific embodiments. The invention is defined by the claims and their full scope of equivalents.

1. A method for testing network integrity comprising:
receiving an incoming data stream;
obtaining a first clock signal from said incoming data stream;
generating a sine and a cosine of phase error between said first clock signal of said incoming data stream and a second clock signal generated by a clock generating device;
using said sine and cosine of phase error to generate said phase error; and
using said phase error to dynamically adjust said second clock signal by feeding said phase error back to said clock generating device.

2. The method of claim 1, wherein said obtaining said first clock signal comprises extracting said first clock signal from said incoming data stream.

3. The method of claim 1, wherein said incoming data stream is Non-Return to Zero (NRZ) formatted data.

4. The method of claim 3, wherein said obtaining said first clock signal comprises transforming said incoming NRZ data stream using a frequency doubler.

5. The method of claim 1, wherein said generating said sine and said cosine of said phase error comprises:
generating a third clock signal by shifting phase of said second clock signal by ninety degrees; and
generating said sine and said cosine of phase error by using at least one mixer to compare said first clock signal with said second clock signal and said third clock signal.

6. The method of claim 1, wherein said generate said phase error comprises computing an arc-tangent from said sine and said cosine of said phase error.

7. The method of claim 1, wherein said clock generating device is a voltage controlled oscillator.

8. The method of claim 7, wherein said voltage controlled oscillator is a dielectric resonator oscillator.

9. The method of claim 7, wherein said using said phase error to dynamically adjust said second clock signal comprises:
generating a tuning voltage from said phase error; and
feeding said tuning voltage to said voltage controlled oscillator.

10. The method of claim 1, wherein said sine and cosine of said phase error are filtered before being used for generating said phase error.

11. The method of claim 1, wherein said said phase error is filtered before being used for adjusting said clock generating device.

12. The method of claim 1, wherein said receiving said incoming data stream comprises means for obtaining said incoming data stream from an optical network.

13. The method of claim 1, further comprising:
using said second clock signal to recover data contained in said incoming data stream.

14. A method for testing network integrity comprising:
receiving an incoming data stream;
obtaining a first clock signal from said incoming data stream;
generating a sine of phase error between said first clock signal of said incoming data stream and a second clock signal generated by a clock generating device;
generating a cosine of phase error between said first clock signal of said incoming data stream and a ninety-degree phase shifted variant of said second clock signal generated by said clock generating device;
using said sine of phase error and said cosine of phase error to generate said phase error; and
using said phase error to dynamically adjust said second clock signal by feeding said phase error back to said clock generating device.

15. A method for testing network integrity comprising:
receiving an incoming data stream;
obtaining a first clock signal from said incoming data stream;
generating a sine and a cosine of phase error between said first clock signal of said incoming data stream and a second clock signal; and
using said sine and cosine of phase error to generate said phase error, wherein said phase error is a measure of jitter.

16. The method of claim 15, wherein said obtaining said first clock signal comprises extracting said first clock signal from said incoming data stream.

17. The method of claim 15, wherein said incoming data stream is Non-Return to Zero (NRZ) formatted data.

18. The method of claim 17, wherein said obtaining said first clock signal comprises transforming said incoming NRZ data stream using a frequency doubler.

19. The method of claim 15, wherein said generating said sine and said cosine of said phase error comprises:
generating a third clock signal by shifting phase of said second clock signal by ninety degrees; and
generating said sine and said cosine of phase error by using at least one mixer to compare said first clock signal with said second clock signal and said third clock signal.

20. The method of claim 15, wherein said generate said phase error comprises computing an arc-tangent from said sine and said cosine of said phase error.

21. The method of claim 15, wherein said second clock signal is a super-stable reference clock.

22. The method of claim 15, wherein said sine and cosine of said phase error are filtered before being used for generating said phase error.

23. The method of claim 15, wherein said receiving said incoming data stream comprises means for obtaining said incoming data stream from an optical network.

24. A method for testing network integrity comprising:
receiving an incoming data stream;
obtaining a first clock signal from said incoming data stream;
generating a sine of phase error between said first clock signal of said incoming data stream and a second clock signal generated by a clock generating device;
generating a cosine of phase error between said first clock signal of said incoming data stream and a ninety-degree phase shifted variant of said second clock signal generated by said clock generating device;
using said sine of phase error and said cosine of phase error to generate said phase error.

25. The method of claim 24, wherein said phase error is used to dynamically adjust said second clock signal be feeding said phase error back to said reference clock source.

26. An apparatus for testing network integrity comprising:
a connector for receiving an incoming data stream;
means for obtaining a first clock signal from said incoming data stream;
a clock generating device for generating a second clock signal;
means for generating a sine and a cosine of phase error between said first clock signal of said incoming data stream and said second clock signal generated by said clock generating device;
means for using said sine and cosine of phase error to extract said phase error; and
a connection device dynamically coupling said phase error to said clock generating device for adjusting said second clock signal.

27. The apparatus of claim 26, wherein said obtaining said first clock signal comprises extracting said first clock signal from said incoming data stream.

28. The apparatus of claim 26, wherein said incoming data stream is Non-Return to Zero (NRZ) formatted data.

29. The apparatus of claim 28, wherein said obtaining said first clock signal comprises transforming said incoming NRZ data stream using a frequency doubler.

30. The apparatus of claim 26, wherein said generating said sine and said cosine of said phase error comprises:
generating a third clock signal by shifting phase of said second clock signal by ninety degrees; and
generating said sine and said cosine of phase error by using at least one mixer to compare said first clock signal with said second clock signal and said third clock signal.

31. The apparatus of claim 26, wherein said extract said phase error comprises computing an arc-tangent from said sine and said cosine of said phase error.

32. The apparatus of claim 26, wherein said clock generating device is a voltage controlled oscillator.

33. The apparatus of claim 32, wherein said voltage controlled oscillator is a dielectric resonator oscillator.

34. The apparatus of claim 32, wherein said adjusting said second clock signal comprises:
generating a tuning voltage from said phase error; and
feeding said tuning voltage to said voltage controlled oscillator via said connection device.

35. The apparatus of claim 26, wherein said sine and cosine of said phase error are filtered before being used for generating said phase error.

36. The apparatus of claim 26, wherein said said phase error is filtered in said connection to said clock generating device.

37. The apparatus of claim 26, wherein said receiving said incoming data stream comprises means for obtaining said incoming data stream from an optical network.

38. The apparatus of claim 26, further comprising:
means for using said second clock signal to recover data contained in said incoming data stream.

39. An apparatus for testing network integrity comprising:
a connector for receiving an incoming data stream;
means for obtaining a first clock signal from said incoming data stream;
a clock generating device for generating a second clock signal;
a phase shifting device for generating a third clock signal by shifting phase of said second clock signal by ninety degrees;
a first mixer for generating a sine of phase error between said first clock signal of said incoming data stream and said second clock signal generated by said clock generating device;
a second mixer for generating a cosine of phase error between said first clock signal of said incoming data stream and said third clock signal generated by said phase shifting device;
means for using said sine of said phase error and said cosine of phase error to extract said phase error; and
a connection device dynamically coupling said phase error to said clock generating device for adjusting said second clock signal.

40. An apparatus for testing network integrity comprising:
a connector for receiving an incoming data stream;
means for obtaining a first clock signal from said incoming data stream;
a reference clock source providing a second clock signal;
means for generating a sine and a cosine of phase error between said first clock signal of said incoming data stream and said second clock signal; and
means for using said sine and cosine of phase error to extract said phase error, wherein said phase error is a measure of jitter.

41. The apparatus of claim 40, wherein said obtaining said first clock signal comprises extracting said first clock signal from said incoming data stream.

42. The apparatus of claim 40, wherein said incoming data stream is Non-Return to Zero (NRZ) formatted data.

43. The apparatus of claim 42, wherein said obtaining said first clock signal comprises transforming said incoming NRZ data stream using a frequency doubler.

44. The apparatus of claim 40, wherein said generating said sine and said cosine of said phase error comprises:
generating a third clock signal by shifting phase of said second clock signal by ninety degrees; and
generating said sine and said cosine of phase error by using at least one mixer to compare said first clock signal with said second clock signal and said third clock signal.

45. The apparatus of claim 40, wherein said generate said phase error comprises computing an arc-tangent from said sine and said cosine of said phase error.

46. The apparatus of claim 40, wherein said reference clock source is a super-stable oscillator device.

47. The apparatus of claim 40, wherein said sine and cosine of said phase error are filtered before being used for generating said phase error.

48. The apparatus of claim 40, wherein said receiving said incoming data stream comprises means for obtaining said incoming data stream from an optical network.

49. An apparatus for testing network integrity comprising:
a connector for receiving an incoming data stream;
means for obtaining a first clock signal from said incoming data stream;
a reference clock source providing a second clock signal;
a quadrature mixer for generating a sine of phase error and a cosine of phase error between said first clock signal from said incoming data stream and said reference clock source; and
means for using said sine of phase error and said cosine of phase error to extract said phase error.

50. The apparatus of claim 49, wherein said phase error is used to dynamically adjust said second clock signal be feeding said phase error back to said reference clock source.
